(19) United States
(12) Patent Application Publication
(10) Pub. No.: US 2026/0350416 A1
(43) Pub. Date: Nov. 5, 2026

(54) ADAPTIVE X-FIELD OPTIMIZER FOR FIXED-DAMPED ANALYTIC PARAMETER UPDATES IN MACHINE-LEARNING TRAINING

(71) Applicant: Jonathan Washburn, Austin, TX (US)

(72) Inventor: Jonathan Washburn, Austin, TX (US)

(21) Appl. No.: 19/662,930

(22) Filed: Apr. 29, 2026

Related U.S. Application Data
(60) Provisional application No. 63/797,338, filed on Apr. 30, 2025.

(51) Int. Cl. G06N 3/0985

(52) U.S. Cl. CPC G06N 3/0985

(57) ABSTRACT

A computer-implemented optimizer for training machine-learning models generates parameter updates by solving a damped linear system formed from a recognition-cost gradient and a curvature matrix associated with the same recognition-cost structure. A recognition-cost objective is evaluated for a current model state, a gradient is computed with respect to model parameters, a curvature matrix is computed from the recognition-cost structure, and a damped linear system formed from the curvature matrix, the gradient, and a fixed damping constant is solved to obtain a parameter-update vector. The model parameters are updated using the parameter-update vector. In preferred embodiments, the damping constant is fixed rather than tuned, is not a learning rate, and is not adjusted during training. The architecture may be implemented in software, distributed systems, or hardware accelerators.

### CROSS-REFERENCE TO RELATED APPLICATIONS

This application claims the benefit of U.S. Provisional Patent Application No. 63/797,338, filed on Apr. 30, 2025, the entire contents of which are incorporated herein by reference to the extent permitted by law.

### BACKGROUND

The present disclosure relates to optimization of machine-learning model parameters and, more particularly, to analytic parameter-update solvers that reduce or eliminate tunable optimizer hyperparameters in model training. More specifically, the present disclosure relates to machine-learning optimization, numerical linear algebra, and training-system architectures in which a recognition-cost-linked gradient and a curvature matrix associated with the same recognition-cost structure are used to form and solve a damped linear system that yields a parameter update. Training of machine-learning models commonly relies on first-order or quasi-first-order optimizers such as stochastic gradient descent, momentum methods, Adam-family optimizers, RMSProp-family optimizers, and related methods. In many practical implementations, such optimizers depend on one or more adjustable controls, including a learning rate, a learning-rate schedule, momentum coefficients, adaptive scaling coefficients, weight decay, damping values, trust-region parameters, line-search parameters, or related optimization-control parameters. These adjustable controls create substantial technical and operational burdens. For example, optimizer performance may be sensitive to task, dataset, architecture, batch size, model scale, or training regime. As a result, training pipelines often require repeated tuning runs, schedule selection, parameter sweeps, or search procedures to identify settings that avoid divergence while still providing acceptable convergence speed. This tuning burden becomes increasingly costly for large models and repeated deployment settings.

Second-order and curvature-aware methods, including natural-gradient methods, quasi-Newton methods, trust-region methods, K-FAC-type approaches, and line-search-based methods, may improve some aspects of convergence behavior. However, such approaches often still rely on adjustable damping, trust-region selection, learning-rate scaling, schedule logic, or related tuning decisions. Accordingly, there remains a need for an optimization architecture that uses curvature information while avoiding reliance on tunable learning-rate-type controls.

A further issue in conventional training systems is that many optimizers maintain optimizer-state buffers, such as momentum buffers, adaptive second-moment buffers, scheduler state, or related persistent state variables. Such state can increase implementation complexity, affect reproducibility, and complicate deployment across software, hardware, and distributed environments. There remains a need for a parameter-update architecture that can generate updates directly from current model state and current training data without dependence on conventional optimizer-state machinery.

The present disclosure addresses these and other technical problems by providing a deterministic parameter-update solver in which a recognition-cost objective is evaluated, a gradient is computed from that recognition-cost objective, and a curvature matrix associated with the same recognition-cost structure is computed. A damped linear system is then formed and solved to obtain a parameter update. In preferred embodiments, the damping is fixed rather than tuned, the update is obtained by a single linear solve per training step, and no learning rate, momentum coefficient, or scheduler is required.

In the framework supporting the disclosed optimizer, a recognition-cost function J(x)=½(x+1/x)31 1 is used in constructing a recognition-cost objective C_RP, and a fixed damping constant is used in the preferred embodiment. The broader theoretical framework from which the preferred damping value is obtained need not be repeated in full here, but provides support for a fixed framework-determined damping architecture rather than a tuned learning-rate architecture.

In implementations using a reciprocal term of the J-cost function, the input to the reciprocal is positive. In some embodiments, a representation-gradient norm or other J input is floored, clamped, or otherwise lower-bounded by a positive stabilization value before reciprocal evaluation. For example, a stabilized J input x_stab may be formed as max(x, epsilon_J), where epsilon_J is a positive numerical-stability value selected for the numeric precision of the implementation, and the J-cost function may be evaluated as J(x_stab)=½(x_stab+1/x_stab)−1. This avoids undefined reciprocal behavior when a representation-gradient norm or other J input is zero or near zero while preserving the disclosed recognition-cost construction. Accordingly, there remains a need for machine-learning training architectures in which parameter updates are generated by solving a damped linear system tied to a recognition-cost objective, with the gradient and curvature both linked to the same recognition-cost structure, thereby reducing or eliminating tunable optimizer hyperparameters while preserving a concrete, implementation-ready training workflow.

### SUMMARY

The present disclosure provides a computer-implemented optimizer for training machine-learning models in which a parameter update is generated by solving a damped linear system formed from a recognition-cost gradient and a curvature matrix associated with the same recognition-cost structure. In contrast to learning-rate-based gradient descent and related adaptive optimizers, the disclosed optimizer obtains the update by a single analytic linear solve per training step rather than by applying a tuned scalar step size to a gradient direction.

In one aspect, the disclosed method includes evaluating a recognition-cost objective C_RP for a current model state, computing a gradient Xi=grad_theta C_RP with respect to model parameters theta, computing a curvature matrix F associated with the same recognition-cost structure, forming a damped linear system of the form:

(F+lambda I)Delta_theta=−Xi

solving the damped linear system to obtain Delta_theta, and updating the model parameters according to theta<-theta+Delta_theta. In preferred embodiments, Xi and F are both computed from, or with respect to, the same recognition-cost structure so that the gradient side and the curvature side remain coupled to the same objective architecture.

In preferred embodiments, the damping constant lambda is fixed rather than tuned, is not a learning rate, and is not adjusted during training. In a preferred embodiment, the damping constant is framework-determined and is given by:

X_opt=phi/pi

lambda=X_opt\hat{ }2=(phi/pi)\hat{ }2

In disclosed examples, lambda is approximately 0.265262302556. In preferred implementations, the damping constant is fixed across minibatches and epochs and is not varied as a function of batch size, task, or model size.

In preferred embodiments, the recognition-cost objective is constructed using a recognition-cost function J(x)=½(x+1/x)−1 and model-state-dependent quantities derived from hidden representations or other internal model structures. In one preferred embodiment, recognition residuals r_j(theta) are defined such that C_RP(theta) is represented as a sum of squared residual terms, and the curvature matrix is computed from a residual Jacobian.

In a preferred curvature embodiment, the curvature matrix is formed as:

F=J_r\hat{ }T J_r

where J_r is a Jacobian associated with the recognition residuals. In this preferred embodiment, F is positive semidefinite by construction. When lambda is positive, the damped system matrix F+lambda I is positive definite, thereby providing a well-defined solve architecture for the parameter update. In preferred embodiments, this positive-definiteness supports direct factorization-based solution methods, including Cholesky factorization.

In one preferred implementation, the update is generated by a single linear solve per training step and does not rely on a separately tuned learning rate, momentum coefficient, learning-rate schedule, trust-region radius, or line-search parameter. In further preferred software embodiments, no optimizer state for momentum or adaptive second moments is required, and no separate scheduler object is required. The disclosed optimizer may therefore be implemented as a direct update pipeline rather than a conventional stateful optimizer stack.

In some embodiments, the curvature matrix is formed for the full parameter space. In other embodiments, particularly for large models, the curvature matrix is approximated in block-diagonal form, and the damped linear system is solved on a per-block basis. Example block definitions may correspond to layers, filters, neuron groups, attention heads, or other architecture-defined parameter subsets. Such blockwise embodiments preserve the same core update structure while improving computational tractability.

In preferred scalable embodiments, each block system matrix is formed as:

A_b=F_b+lambda I_b

and solved to obtain a block update Delta_theta_b. In preferred embodiments using positive-semidefinite block curvature and positive lambda, Cholesky factorization is used to generate the block update. Alternative solver embodiments may use other numerically stable linear-solve techniques while preserving the fixed-damped analytic update architecture.

In some embodiments, the disclosed optimizer is deterministic in the sense that identical inputs produce identical update vectors. Deterministic behavior may be preserved by fixed block definitions, fixed block ordering, fixed damping, and direct solution of the damped system without stochastic learning-rate scheduling or momentum-state evolution.

The disclosed optimizer may be implemented in software, hardware, or combinations thereof. Software embodiments may use automatic differentiation frameworks to compute gradients and residual Jacobians. Hardware embodiments may include GPU, FPGA, ASIC, NPU, or related accelerator implementations for repeated damped solves, including repeated small block solves. Distributed embodiments may assign different parameter blocks to different compute devices and synchronize updated parameters after local solves. These embodiments remain subordinate to the core invention, which is the fixed-damped analytic update architecture itself.

The disclosure further supports computer-readable-medium embodiments storing instructions that, when executed by one or more processors, cause performance of the disclosed method, and training-system embodiments including modules for recognition-cost computation, gradient computation, curvature computation, fixed-damping provision, damped solving, and parameter update.

Disclosed examples and validation pathways include benchmark comparisons on image-model training, language-model fine-tuning, and edge-device training; ablation of damping values including lambda=0 and lambda=X_opt\hat{ }2; determinism testing using repeated identical inputs; and engineering tests for hardware-accelerated solve embodiments. These examples support make-and-use disclosure and illustrate performance and implementation characteristics, but do not redefine the core identity of the invention.

Formal verification support is also disclosed for preferred structural aspects of the optimizer, including framework-linked damping, damping positivity, positive-semidefinite curvature, positive-definite damped systems, existence of Cholesky factorizations in preferred embodiments, descent behavior, deterministic update behavior, and parameter-free characterization. Such formal support reinforces the disclosed fixed-damped optimizer architecture and its preferred embodiments.

These and other features, embodiments, and advantages of the present disclosure will become more apparent from the following description, drawings, and claims.

### BRIEF DESCRIPTION OF THE FIGURES

FIG. 1 is a block diagram of an X-Field optimizer training system showing a recognition-cost computation path, a gradient path, a curvature path, a fixed-damping input, a linear solver, and a parameter update path.

FIG. 2 is a dataflow diagram showing a mathematical update pipeline from model parameters and recognition-cost computation to gradient generation, curvature generation, damped-system formation, solution of an update vector, and parameter update.

FIG. 3 is a diagram showing recognition-cost computation from model inputs, forward-pass activations, hidden representations, representation-gradient extraction, residual generation, and aggregation into a recognition-cost objective.

FIG. 4 is a diagram showing curvature-generation embodiments, including recognition residuals, Jacobian formation, positive-semidefinite curvature construction, and alternative curvature branches.

FIG. 5 is a diagram showing block partitioning and blockwise damped-solve flow, including example layer blocks, filter blocks, attention-head blocks, blockwise system-matrix formation, factorization, and block update generation.

FIG. 6 is a flowchart showing training-loop integration, including minibatch intake, forward pass, hidden-state extraction, residual and gradient computation, block enumeration, update application, and iterative training progression.

FIG. 7 is a block diagram showing a distributed training embodiment in which multiple processors or accelerators receive block assignments, perform local solves, and synchronize updated parameters.

FIG. 8 is a block diagram showing a hardware-accelerated embodiment including a host processor, a fixed-damping register, a block matrix buffer, a factorization engine, a forward and back substitution engine, and an update output path.

FIG. 9 is a diagram showing a validation and ablation framework including benchmark-task selection, baseline optimizer comparison, damping-value sweep testing, determinism testing, and acceptance-criteria evaluation.

### DETAILED DESCRIPTION

The present disclosure provides a deterministic, fixed-damped analytic optimizer for updating parameters of a machine-learning model. In the core embodiment, a recognition-cost objective C_RP is evaluated for a current model state, a corresponding gradient Xi is computed with respect to model parameters theta, a curvature matrix F associated with the same recognition-cost structure is computed, and the parameter update is obtained by solving a damped linear system of the form (F+lambda I) Delta_theta=−Xi, followed by updating the model parameters according to theta<−theta+Delta_theta. In preferred embodiments, the update is obtained by a single linear solve per training step rather than by applying a tuned scalar learning rate to a gradient direction.

As used herein, theta denotes a current parameter vector or parameter tensor collection of a machine-learning model, Delta_theta denotes an update to such parameters, Xi denotes a recognition-cost gradient with respect to theta, F denotes a recognition-cost curvature matrix associated with the same recognition-cost structure used to compute Xi, lambda denotes a damping constant, and I denotes an identity matrix or block identity matrix of corresponding dimension. In blockwise embodiments, a block index b may identify a selected parameter subset, F_b may denote a block curvature matrix, I_b may denote a corresponding block identity matrix, and Delta_theta_b may denote a block update.

For claim-drafting purposes, symbolic expressions may be restated in prose. Thus, the damped linear system may be expressed as a system in which a curvature matrix plus a damping constant times an identity matrix is applied to a parameter-update vector and set equal to a negative gradient vector. Likewise, a curvature matrix formed from a residual Jacobian transpose multiplied by the residual Jacobian may be described in prose as a Jacobian-based positive-semidefinite curvature construction.

In preferred embodiments, the damping constant lambda is fixed rather than tuned, where X_opt=phi/pi and lambda=X_opt\hat{ }2=(phi/pi)\hat{ }2. The damping constant is not a learning rate, is not adjusted during training, and, in preferred embodiments, is not varied across minibatches, epochs, tasks, batch sizes, or model sizes. In disclosed examples, lambda is approximately 0.265262302556.

As used herein, “framework-determined” means that the fixed damping constant is specified by a predetermined analytic relationship disclosed in the specification and is not selected by empirical hyperparameter search for a particular dataset, task, model size, batch size, or training run. In preferred embodiments, the framework-determined damping constant is established before training begins and remains unchanged across minibatches and epochs.

In preferred embodiments, the fixed damping value lambda=X_opt\hat{ }2=(phi/pi)\hat{ }2 is not selected by hyperparameter tuning. Rather, the value is derived from dimensional analysis of the recognition-cost functional C_RP and from the same stationary-action framework that determines X_opt=phi/pi in the supporting Recognition Science framework. In this preferred architecture, the damping is the square of the framework coupling quantity, and is therefore fixed, task-independent, and not adjusted during training. This preferred derivation-based formulation distinguishes the disclosed damping architecture from conventional optimizers that rely on tuneable learning-rate, damping, trust-region, or schedule parameters.

In preferred embodiments, the disclosed optimizer does not require a conventional optimizer-state stack. For example, no momentum buffer, adaptive second-moment buffer, or separate learning-rate scheduler state need be maintained. In one preferred software embodiment, no separate optimizer object is required, and the update is produced directly by the disclosed solve pipeline.

The disclosed optimizer can be implemented with a full parameter-space solve or with parameter subsets or blocks. It can also be implemented in software, distributed systems, or hardware accelerators. However, such embodiments remain subordinate to the core invention, which is the fixed-damped analytic solve architecture tied to a recognition-cost objective on both the gradient side and the curvature side.

The disclosed embodiments share a common inventive concept, namely generation of a parameter update by solving a damped linear system formed from a recognition-cost-linked gradient, a recognition-cost-linked curvature matrix, and a fixed damping constant that is not tuned during training. The disclosed update architecture improves machine-learning training by replacing tunable learning-rate-type update control with a fixed-damping, curvature-linked linear-solve pipeline that changes how parameter updates are computed, stored, and applied in software and hardware training systems. Method, software, system, distributed, and hardware embodiments are disclosed as implementation forms of that common inventive concept.

The disclosed optimizer does not merely output a mathematical result. In operation, the solved parameter-update vector modifies stored model parameter values used by subsequent forward passes of the machine-learning model. The modified stored parameter values alter subsequent activations, predictions, gradients, recognition-cost values, and training trajectory. In preferred embodiments, the fixed-damped solve also changes operation of the training system by eliminating learning-rate scheduler state, momentum-state updates, and adaptive-moment optimizer buffers.

In one preferred full-step formulation, each training step proceeds according to the following ordered sequence:
Step 1: compute C_RP(theta) for a current minibatch or current model state.
Step 2: compute Xi=grad_theta C_RP, for example using automatic differentiation.
Step 3: compute F, including in preferred embodiments a block-diagonal curvature approximation such as a Gauss-Newton or Fisher-style curvature linked to the same recognition-cost structure.
Step 4: solve (F_b+lambda I) Delta_theta_b=−Xi_b on a per-block basis, or solve (F+lambda I) Delta_theta=−Xi for a full-system embodiment.
Step 5: update model parameters according to theta<−theta+Delta_theta.

This ordered sequence preserves the core architecture of the invention, namely recognition-cost-linked gradient generation, recognition-cost-linked curvature generation, fixed damping, a single linear solve per training step, and direct parameter update.

For avoidance of doubt, a curvature matrix is “associated with the same recognition-cost objective” when the curvature matrix is computed from derivatives of a residual vector, Jacobian, or equivalent derivative structure derived from the same recognition-cost objective that is used to compute the gradient. In preferred embodiments, the gradient and curvature are not computed from unrelated objective functions.

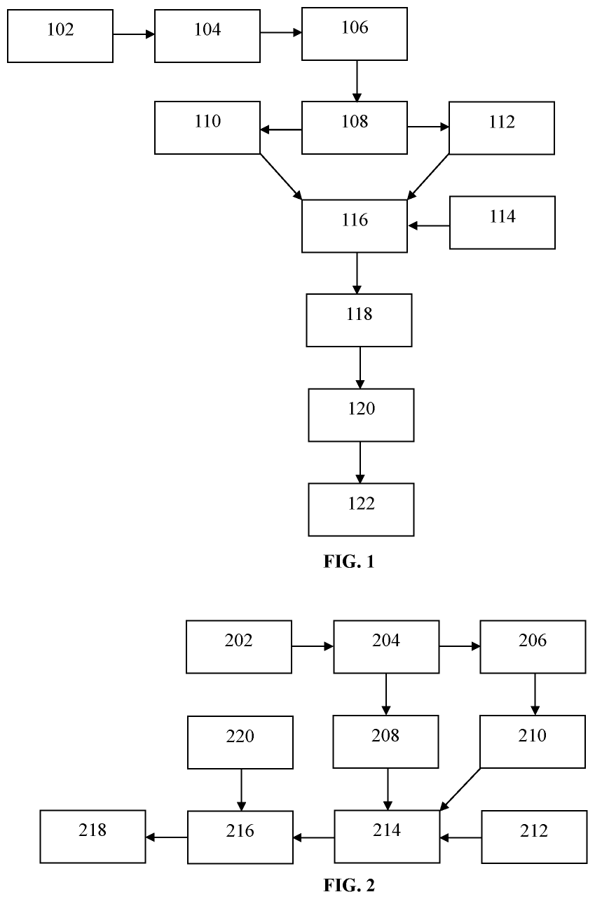

FIG. 1 depicts an overall X-Field optimizer training system. The system includes minibatch input 102, model forward-pass engine 104, hidden-state or model-state extractor 106, recognition-cost computation module 108, gradient computation module 110, curvature computation module 112, fixed-damping generator or fixed-damping register 114, damped linear solver 116, parameter-update module 118, updated-parameter store 120, and trained-model output 122.

In the embodiment of FIG. 1, minibatch input 102 is provided to model forward-pass engine 104, which generates activations, outputs, and one or more internal states. Hidden-state or model-state extractor 106 provides one or more internal representations to recognition-cost computation module 108. Recognition-cost computation module 108 generates a recognition-cost objective for the current model state. Gradient computation module 110 and curvature computation module 112 respectively compute Xi and F with respect to the same recognition-cost structure. Fixed-damping generator or fixed-damping register 114 supplies lambda to damped linear solver 116, which solves for Delta_theta. Parameter-update module 118 applies the solved update to the model parameters, and updated parameters are stored in updated-parameter store 120 for continued training or inference, yielding trained-model output 122.

FIG. 2 depicts a mathematical update pipeline. The pipeline includes current parameter vector 202, recognition-cost function C_RP 204, recognition residual vector 206, gradient vector Xi 208, curvature matrix F 210, fixed damping lambda 212, damped system matrix F+lambda I 214, solved update vector Delta_theta 216, updated parameter vector 218, and optional descent or determinism verification output 220.

In the embodiment of FIG. 2, current parameter vector 202 is used to evaluate recognition-cost function 204 and recognition residual vector 206. Gradient vector Xi 208 is computed from the recognition-cost structure, and curvature matrix F 210 is computed with respect to that same recognition-cost structure. Fixed damping lambda 212 is added to curvature matrix F 210 to produce damped system matrix 214, which is solved to obtain solved update vector 216. Updated parameter vector 218 is produced by applying solved update vector 216 to current parameter vector 202. Optional output 220 may record one or more diagnostics, such as whether Xi\hat{ }T Delta_theta is negative, whether repeated identical inputs produce identical Delta_theta, or whether a factorization-based solve completed successfully.

In preferred embodiments, the same-objective linkage shown in FIG. 2 is a substantive feature of the disclosed update architecture. More particularly, Xi 208 and F 210 are both computed from, or with respect to, the same recognition-cost structure, such as the same recognition-cost function 204 or the same recognition residual vector 206. This same-objective linkage distinguishes the disclosed update architecture from generic damped second-order techniques that may combine unrelated objectives, unrelated curvatures, or separately tuned step-size controls.

The disclosed optimizer further differs from conventional damped second-order methods because the gradient side and curvature side are linked to the recognition-cost structure, the damping value is fixed by the disclosed framework rather than selected by line search, trust-region adjustment, empirical damping search, or learning-rate tuning, and the solved update is applied directly without multiplying the solved update by a separately tuned learning-rate scalar. Thus, the disclosed update is not merely a conventional second-order step with a different damping value, but a same-recognition-cost, fixed-damped solve architecture.

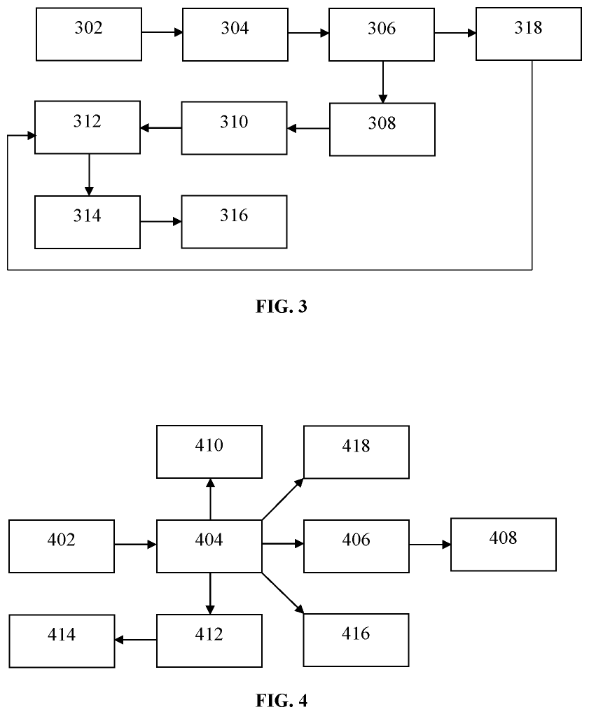

FIG. 3 depicts a recognition-cost computation subsystem. The subsystem includes minibatch data 302, forward-pass model 304, hidden representation psi 306, representation-gradient extractor 308, cost function J(x) 310, recognition residual generator 312, aggregated recognition-cost output C_RP 314, gradient output Xi 316, and optional discrete-Laplacian or state-processing stage 318.

In the embodiment of FIG. 3, minibatch data 302 is processed by forward-pass model 304 to produce hidden representation psi 306 or another model-state representation. Representation-gradient extractor 308 computes one or more representation-dependent gradient quantities, such as grad_x psi_j(theta). Cost function module 310 applies a recognition-cost function J(x) to one or more representation-dependent quantities. In one preferred embodiment, J(x)=½(x+1/x)−1. Recognition residual generator 312 forms recognition residuals, and aggregated recognition-cost output C_RP 314 is formed from such residuals. Gradient output Xi 316 is then computed with respect to the model parameters, for example by automatic differentiation. Optional state-processing stage 318 may apply one or more transformations, including representation selection, state smoothing, discrete-Laplacian processing, or other model-state preprocessing.

In one preferred embodiment, the recognition-cost objective is defined as C_RP(theta)=sum_j J(∥grad_x psi_j(theta)∥). In one preferred residual-based implementation, recognition residuals are defined as r_j(theta)=sqrt(J(∥grad_x psi_j(theta)∥)), so that C_RP(theta)=sum_j r_j(theta)\hat{ }2. Other mathematically equivalent or implementation-equivalent residual groupings may be used, provided that the gradient Xi and curvature F remain linked to the same recognition-cost structure.

Inputs to the subsystem may include current model parameters, current minibatch data, forward-pass activations, hidden states, intermediate representations, or other model-state information. Outputs may include scalar recognition cost, recognition residual vector, gradient vector, and one or more derivative structures used downstream for curvature formation. In preferred embodiments, one backward pass is sufficient to generate Xi.

FIG. 4 depicts a curvature-generation subsystem. The subsystem includes recognition residual vector 402, residual Jacobian J_r 404, preferred curvature matrix J_r\hat{ }T J_r 406, positive-semidefinite property indicator 408, full-matrix embodiment branch 410, block partitioner 412, blockwise curvature matrices 414, alternative second-derivative proxy branch 416, and optional Fisher-style or Gauss-Newton-style branch 418.

In a preferred embodiment shown in FIG. 4, recognition residual vector 402 and residual Jacobian J_r 404 are used to form preferred curvature matrix 406 according to F=J_r\hat{ }T J_r. In this embodiment, F is positive semidefinite by construction, as indicated by positive-semidefinite property indicator 408. Alternative embodiments include a full-matrix embodiment branch 410, blockwise embodiments produced through block partitioner 412 and blockwise curvature matrices 414, direct second-derivative proxy branch 416 for very small parameter groups, and other Fisher-style or Gauss-Newton-style branches 418 that remain linked to the same recognition-cost structure.

In one preferred embodiment, curvature elements are given by F_ij=sum_k (partial r_k/partial theta_i)(partial r_k/partial theta_j). In matrix form, this is F=J_r\hat{ }T J_r, where J_r denotes a Jacobian of the recognition residual vector with respect to theta. This construction is preferred because it preserves same-objective linkage with the recognition-cost objective and yields a positive-semidefinite matrix suitable for the preferred damped solve architecture.

In alternative embodiments, the curvature may be a Gauss-Newton form, Fisher-style approximation, direct second-derivative proxy, or another recognition-cost-linked curvature approximation. Such alternatives are subordinate to the preferred residual-Jacobian construction and should not be understood as altering the core requirement that the curvature be associated with the same recognition-cost structure used to generate Xi.

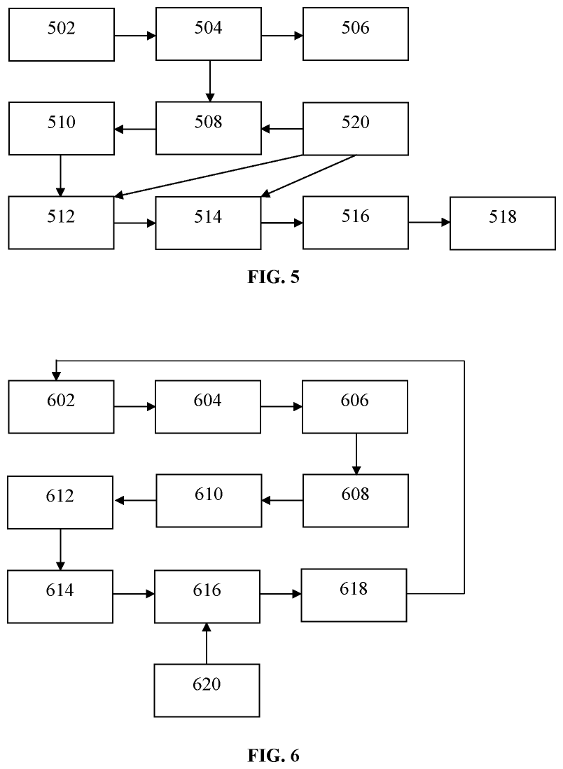

FIG. 5 depicts a blockwise solver architecture. The architecture includes layer block 502, filter block 504, attention-head block 506, block system matrix A_b 508, Cholesky factor 510, forward-solve stage 512, back-solve stage 514, block update vector Delta_theta_b 516, updated block parameters 518, and fixed block-order controller 520.

In the embodiment of FIG. 5, one or more architecture-defined parameter subsets are treated as blocks. For example, a block may correspond to a layer block 502, a filter block 504, or an attention-head block 506. For each block, block system matrix A_b 508 is formed according to A_b=F_b+lambda I_b. In a preferred implementation, Cholesky factor 510 is computed so that A_b=L_b L_b\hat{ }T, forward-solve stage 512 computes an intermediate vector z from L_b z=−Xi_b, and back-solve stage 514 computes block update vector Delta_theta_b 516 from L_b\hat{ }T Delta_theta_b=z. Updated block parameters 518 are then written back to the model state. Fixed block-order controller may provide deterministic ordering for block enumeration and update application.

In preferred deterministic embodiments, deterministic reproduction of a parameter-update vector is obtained by maintaining fixed block definitions, fixed block ordering, a fixed damping value, and a deterministic linear-solver implementation for identical model parameters and identical input data.

In one preferred blockwise solve embodiment, the following sequence is performed for each block b:
Step 1: form A_b=F_b+X_opt\hat{ }2 I_b.
Step 2: compute a Cholesky factorization A_b=L_b L_b\hat{ }T.
Step 3: perform a forward solve L_b z=−Xi_b.
Step 4: perform a back solve L_b\hat{ }T Delta_theta_b=z.
Step 5: update block parameters according to theta_b<−theta_b+Delta_theta_b.

This preferred ordered factorization-and-solve sequence provides a concrete implementation pathway for generating Delta_theta_b from a positive-definite damped block system.

The use of blocks can improve tractability for large models. Representative, non-limiting examples include a 3×3 convolution filter block having nine parameters, a fully connected neuron-group block, and an attention-head-sized block. Block boundaries may be selected according to architecture topology, model graph order, layer structure, tensor grouping, or other predetermined partition logic. Such blockwise embodiments preserve the core fixed-damped analytic solve while reducing computational cost relative to a full dense solve.

FIG. 6 depicts a training loop. The training loop includes data loader 602, forward pass 604, hidden-state extraction 606, recognition residual and cost computation 608, gradient and curvature computation 610, parameter-block enumeration 612, per-block or full solve 614, parameter update application 616, next-minibatch progression 618, and optional no-optimizer-state path 620.

In the embodiment of FIG. 6, data loader 602 provides a minibatch to forward pass 604. Hidden-state extraction 606 obtains one or more intermediate model states. Recognition residual and cost computation 608 produces the recognition-cost objective and any residual structures needed for downstream derivatives. Gradient and curvature computation 610 generates Xi and F with respect to the same recognition-cost structure. Parameter-block enumeration 612 identifies either the full parameter space or one or more blocks. Per-block or full solve 614 then computes Delta_theta or Delta_theta_b, and parameter update application 616 applies the solved update to the model parameters. Next-minibatch progression 618 repeats the process. Optional path 620 illustrates a software embodiment in which no separate optimizer-state machinery is required. In preferred embodiments, each training step uses a single linear solve per full system or a single linear solve per selected block, and no separate learning-rate selection, momentum update, adaptive-moment update, or scheduler step is required. In one preferred implementation, the pipeline can be implemented directly in model-training code without instantiating a conventional optimizer object.

In one preferred training-loop embodiment, for each batch in a data loader, a model receives batch input and produces an output together with one or more hidden states. A hidden-state retrieval operation obtains a current hidden representation psi. Recognition residuals are then computed from psi. For each parameter block in a parameter-block enumeration, a block residual function is defined, and the disclosed fixed-damped update step is executed for that block. This training-loop embodiment illustrates direct integration of the disclosed optimizer into an iterative training process without requiring conventional learning-rate scheduling or momentum-state update logic.

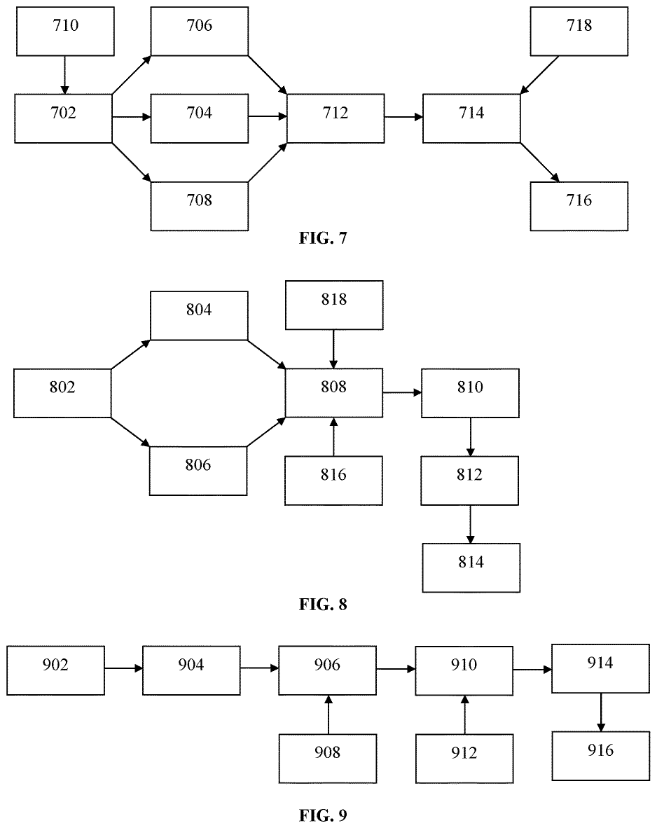

FIG. 7 depicts a distributed training system. The system includes coordinator 702, first compute device 704, second compute device 706, nth compute device 708, block assignment map 710, local curvature-and-solve path 712, parameter synchronization path 714, merged updated-parameter state 716, and optional communication-control module 718.

In the embodiment of FIG. 7, coordinator 702 assigns parameter blocks using block assignment map 710 across compute devices 704, 706, 708. Each device performs local curvature-and-solve operations 712 on its assigned blocks. Updated parameters are then exchanged through parameter synchronization path 714 to form merged updated-parameter state 716. Optional communication-control module 718 may manage synchronization timing, aggregation rules, compression, or scheduling. In one preferred distributed embodiment, the communication path primarily exchanges updated parameters or block updates rather than full dense Hessian-like structures.

FIG. 8 depicts a hardware-accelerated solver system. The system includes host processor 802, fixed-damping register 804, block matrix buffer 806, factorization engine 808, forward/back substitution engine 810, update output buffer 812, memory interface 814, FPGA embodiment 816, and ASIC or NPU embodiment 818.

In the embodiment of FIG. 8, host processor 802 supplies fixed damping to fixed-damping register 804 and supplies block matrices to block matrix buffer 806. Factorization engine 808 performs a factorization, such as Cholesky factorization, on damped block matrices, and forward/back substitution engine 810 generates update outputs. Update output buffer 812 stores solved updates, and memory interface 814 transfers data to and from the accelerator. FPGA embodiment 816 and ASIC or NPU embodiment 818 illustrate alternative hardware platforms for repeated block solves. Hardware metrics such as cycle count, throughput, power, or area may be disclosed as engineering examples, but such values are not required limitations of the core invention.

In one disclosed engineering example, repeated 9×9 Cholesky block solves are implemented for convolution-filter blocks on an FPGA platform. In one such example, a 9×9 Cholesky solve is disclosed as requiring approximately 81 cycles at 250 MHz, corresponding to approximately 0.324 microseconds per block, with approximately 2000 blocks per second and approximately 18 watts of power in a representative embedded-training scenario. In another disclosed engineering embodiment, on-chip memory usage is described for repeated small block matrices, and supported block classes include convolutional, fully connected, and attention-type blocks. These engineering examples provide concrete implementation guidance for hardware embodiments, while remaining subordinate to the fixed-damped analytic update architecture itself.

In preferred embodiments, the fixed damping value used in hardware is stored as a register value or compile-time constant and is not tuned during training. In one engineering embodiment, a repeated small-block solver is used for blocks corresponding to convolution filters, fully connected parameter groups, or attention-head parameter groups. A representative non-limiting example is a nine-parameter convolution-filter block solved as a nine-by-nine damped linear system. Example engineering metrics may include factorization cycle count, operating frequency, per-block latency, power, and on-chip memory usage, provided such metrics are treated as implementation examples rather than required claim limitations. Repeated small matrix solves, such as repeated 9×9 solves for convolution-filter blocks, are examples of accelerator-friendly embodiments, but the disclosed invention is not limited to any particular block size or solver fabric.

FIG. 9 depicts a validation framework. The framework includes benchmark task selector 902, baseline optimizer set 904, X-Field optimizer under test 906, lambda-sweep module 908, convergence-metric collector 910, determinism-test module 912, acceptance-criteria evaluator 914, and validation report output 916.

In the embodiment of FIG. 9, benchmark task selector 902 identifies one or more training tasks, such as image-model training, language-model fine-tuning, or edge-device training. Baseline optimizer set 904 provides one or more comparison optimizers. X-Field optimizer under test 906 is executed using the disclosed fixed-damped solve architecture. Lambda-sweep module 908 tests different damping values, convergence-metric collector 910 records epochs, accuracy, perplexity, wall time, or other metrics, determinism-test module 912 evaluates whether identical inputs produce identical updates, and acceptance-criteria evaluator 914 assesses whether predetermined criteria are satisfied. Validation report output 916 records test results.

In one validation embodiment, acceptance criteria include at least one of: successful factorization of each damped system matrix; a negative inner product between the gradient and the solved update vector; deterministic reproduction of the solved update vector for repeated identical inputs; convergence to a target accuracy within a predetermined epoch count; convergence to a target perplexity within a predetermined epoch count; or successful completion of a damping-ablation test in which under-damped, preferred, and over-damped operating regions are distinguishable.

In one preferred validation pathway, a benchmark task such as ResNet-50/ImageNet training is used to determine whether a target accuracy level is reached in a specified number of epochs. In another validation pathway, a language-model fine-tuning task is used to determine whether a target perplexity is achieved within a specified epoch range. In another validation pathway, lambda is swept across a range including zero, under-damped values, X_opt\hat{ }2, and over-damped values to evaluate divergence, solver failure, convergence speed, and stability. In another validation pathway, repeated identical inputs are used to confirm deterministic reproduction of Delta_theta.

In one determinism test, repeated execution using identical model parameters, identical input data, identical block definitions, identical block order, and identical solver implementation reproduces the same parameter-update vector to a predetermined numerical tolerance or floating-point precision criterion.

In one disclosed image-model example, a ResNet-50/ImageNet training configuration using the disclosed optimizer reaches 75 percent top-1 accuracy in approximately 18 epochs, compared with approximately 90 epochs for stochastic gradient descent in the disclosed comparison. In one disclosed language-model example, a GPT-2 fine-tuning configuration reaches perplexity approximately 37 in approximately 12 epochs, compared with approximately 41 in approximately 50 epochs for an Adam baseline in the disclosed comparison. In one disclosed edge-training example, a MobileNet-class model trained on an edge device exhibits a higher per-batch step time than an Adam baseline but lower total training time due to reduced epochs to convergence. These worked examples are disclosed as validation examples and implementation guidance and should not be read as limiting the invention to any particular benchmark result. In one disclosed damping-ablation example, lambda is swept across values including 0, 0.01, X_opt\hat{ }2, and 1.0. In that example, lambda=0 produces Cholesky failure because F is not positive definite, together with divergence; lambda=0.01 produces under-damped slow convergence; lambda=X_opt\hat{ }2=0.265262302556 produces preferred convergence behavior; and lambda=1.0 produces over-damped slower behavior tending toward gradient-descent-like performance. This ablation example is disclosed as evidence supporting the preferred fixed damping value and its role in conditioning the solve.

Returning to the core mathematical structure, in a preferred embodiment the damped system matrix is A=F+lambda I. Since F is positive semidefinite in preferred Gauss-Newton, Fisher-style, and J_r\hat{ }T J_r curvature embodiments, and since lambda=X_opt\hat{ }2 is positive, the matrix F+lambda I is positive definite. This means that, in preferred embodiments, Cholesky factorization succeeds for each block or full-system solve without indefinite-factorization failure. It further means that when Xi is nonzero, Xi\hat{ }T Delta_theta is negative, so the solved update is a descent direction in the gradient sense. In preferred deterministic embodiments, the same inputs produce the same Delta_theta. These structural consequences are also supported by formal verification in the disclosed theorem-backed embodiments. Compared with conventional second-order methods, the disclosed architecture uses a fixed damping value rather than an adjustable learning rate, adaptive damping schedule, or trust-region radius. In one comparative embodiment, optimization methods may be categorized according to whether damping or step-size control is adjustable during training. Representative examples include Newton-type methods without fixed positive damping, line-search-based methods, L-BFGS methods with line-search or related adjustment, K-FAC-type methods with adaptive damping, and natural-gradient methods with adjustable per-step scaling. In contrast, the disclosed X-Field optimizer uses a fixed damping quantity in the damped linear system and does not require per-step or per-epoch tuning of a learning-rate-type control. For example, while Newton-type, L-BFGS, natural-gradient, and K-FAC-type approaches may rely on tuneable damping, line search, or per-step scaling, the preferred X-Field optimizer architecture uses lambda=X_opt\hat{ }2 as a fixed damping quantity in the damped linear solve.

The disclosed optimizer may be implemented in software using automatic differentiation. In one reference implementation, a residual function for a parameter block returns a recognition residual vector such that C_RP is the sum of squared residuals. The gradient Xi may be computed using an autodiff call, the residual Jacobian J_r may be computed using a Jacobian routine, the curvature matrix may be formed as J_r\hat{ }T J_r, the damped matrix may be formed by adding lambda times an identity matrix, and the solve may be performed by a dense or blockwise linear solve routine. Such a software implementation is exemplary and does not limit the invention to a particular programming language, framework, or library.

The recognition-cost computation module, gradient computation module, curvature computation module, damped linear solver, and parameter-update module may be implemented as software components executed by one or more processors, as dedicated hardware circuitry, or as mixed hardware-software logic. Where implemented in software, the operations may be executed from instructions stored in memory and may share one or more memory-resident data structures representing parameters, residuals, gradients, curvature matrices, damped matrices, and solved updates.

In one reference software implementation, a constant XOPT is set to (1+5\hat{ }0.5)/(2*pi), and a constant LAMBDA is set to XOPT ** 2. A residual function for a parameter block returns a residual vector r(p) such that C_RP(p)=sum((r(p))\hat{ }2). The gradient Xi is computed from the squared residual sum using automatic differentiation. A residual Jacobian J_r is computed using a Jacobian routine applied to the residual function. The curvature matrix is formed as F=J_r\hat{ }T J_r. A damped system matrix A is formed as F+LAMBDA times an identity matrix. A linear solver then computes delta=solve(A, −Xi), and the parameter block is updated directly using the solved delta value. This reference software embodiment illustrates a direct implementation path for the fixed-damped analytic update architecture and further illustrates that no separate optimizer object, no learning-rate scheduler, and no momentum state are required in preferred embodiments.

In one preferred software embodiment, the update pipeline is organized as a direct method rather than as a stateful optimizer stack. A model is evaluated on a minibatch, one or more hidden states are obtained, recognition residuals are computed, Xi and F are produced, the damped system is solved, and parameters are updated. This embodiment may be implemented without storing momentum-state history, adaptive second-moment history, or learning-rate schedule state.

In smaller-model embodiments, the full parameter-space curvature may be formed and solved directly. In larger-model embodiments, a block-diagonal approximation may be employed. In still other embodiments, only a subset of blocks may be selected for update at a given step. In each such case, the core architecture remains the same: recognition-cost-linked gradient generation, recognition-cost-linked curvature generation, fixed damping, damped linear-system formation, and solve-based parameter update.

In some embodiments, the optimizer is used to train image models, language models, edge-device models, or scientific machine-learning models. In other embodiments, the optimizer is used as part of a larger objective-plus-solver stack in which a recognition-cost objective and a fixed-damped analytic solver together provide a training architecture. Such downstream embodiments are illustrative and do not alter the core identity of the invention as the disclosed update rule and solver architecture.

Formal-verification support may be included as part of the disclosure for preferred structural aspects of the optimizer. In one disclosed formal-verification embodiment, machine-checked analysis supports the following structural properties: damping_from_phi, namely lambda=(phi/pi)\hat{ }2; damping_positive, namely lambda>0; curvature_psd, namely F=J_r\hat{ }T J_r implies F is positive semidefinite; system_positive_def, namely F positive semidefinite together with lambda>0 implies F+lambda I is positive definite; cholesky_well_defined, namely a Cholesky factorization exists for F+lambda I; update_descent, namely Xi !=0 implies Xi\hat{ }T Delta_theta<0; update_deterministic, namely the same inputs produce the same Delta_theta; and parameter_free, namely the damping architecture is fixed by X_opt\hat{ }2 together with the framework relation phi\hat{ }2=phi+1. In preferred drafting order, these theorem-backed support layers are presented in the same order as the structural reasoning chain: fixed damping value, positivity of lambda, positive-semidefinite curvature, positive-definite damped system, Cholesky existence, descent behavior, deterministic update behavior, and parameter-free characterization. The disclosed embodiments are not limited to the specific examples, software environments, datasets, hardware targets, or benchmark tasks described herein. Rather, the invention includes the fixed-damped analytic solve architecture and its method, system, and computer-readable-medium implementations, together with preferred, optional, alternative, downstream, and continuation-worthy embodiments consistent with the present disclosure.

What is claimed is:

1. A computer-implemented method for updating parameters of a machine-learning model, the method comprising:
computing a recognition-cost objective for a current model state; computing, with respect to model parameters of the machine-learning model, a gradient associated with the recognition-cost objective; computing a curvature matrix associated with the same recognition-cost objective or with a recognition residual structure derived from the same recognition-cost objective; forming a damped linear system from the curvature matrix, the gradient, and a fixed damping constant; solving the damped linear system to obtain a parameter-update vector; andupdating the model parameters using the parameter-update vector, wherein the fixed damping constant comprises X_opt squared, where X_opt equals a ratio of the golden ratio to pi, and wherein the fixed damping constant is not a learning rate, is not adjusted during training, and is used in place of a tunable learning-rate-type hyperparameter.

2. The method of claim 1, wherein the damped linear system comprises a system in which the curvature matrix plus the fixed damping constant times an identity matrix is applied to the parameter-update vector and set equal to a negative gradient vector.

3. The method of claim 1, wherein the gradient and the curvature matrix are both computed from, or with respect to, the same recognition-cost objective and a recognition residual structure derived from that recognition-cost objective.

4. The method of claim 1, wherein the curvature matrix is computed from a derivative structure derived from the same recognition-cost objective used to compute the gradient.

5. The method of claim 1, wherein the parameter-update vector is obtained by a single linear solve per training step.

6. The method of claim 1, wherein no learning rate, momentum coefficient, or learning-rate schedule is used.

7. The method of claim 1, wherein no optimizer state storing momentum values or adaptive second-moment values is maintained.

8. The method of claim 7, wherein the fixed damping constant is based on a square of a ratio of the golden ratio to pi.

9. The method of claim 8, wherein the fixed damping constant is approximately 0.265262302556.

10. The method of claim 1, wherein the recognition-cost objective uses a cost function equal to one-half of a sum of an input quantity and a reciprocal of the input quantity, minus one.

11. The method of claim 1, wherein deterministic reproduction of the parameter-update vector is obtained by maintaining fixed parameter-block definitions, fixed parameter-block ordering, and a fixed damping constant for identical model parameters and identical input data.

12. The method of claim 1, further comprising evaluating at least one acceptance criterion selected from successful factorization of the damped linear system, negative inner product between the gradient and the parameter-update vector, deterministic reproduction for repeated identical inputs, target-accuracy attainment within a predetermined epoch count, and target-perplexity attainment within a predetermined epoch count.

13. The method of claim 1, wherein the curvature matrix is associated with the same recognition-cost objective by being computed from a Jacobian of a residual vector whose squared terms define the recognition-cost objective.

14. The method of claim 13, wherein the recognition-cost objective is represented as a sum of squared residual terms.

15. The method of claim 14, wherein the curvature matrix is formed from a transpose of the Jacobian multiplied by the Jacobian.

16. The method of claim 15, wherein the curvature matrix is positive semidefinite by construction.

17. The method of claim 16, wherein the fixed damping constant is positive such that the damped linear system is positive definite.

18. The method of claim 17, wherein solving the damped linear system comprises Cholesky factorization.

19. The method of claim 1, wherein the curvature matrix is approximated in block-diagonal form and the damped linear system is solved independently for a plurality of parameter blocks.

20. A machine-learning training system comprising:
circuitry and/or one or more processors executing instructions, configured to compute a recognition-cost objective for a current model state;
circuitry and/or one or more processors executing instructions, configured to compute, with respect to model parameters of a machine-learning model, a gradient associated with the recognition-cost objective;
circuitry and/or one or more processors executing instructions, configured to compute a curvature matrix associated with the same recognition-cost objective or with a recognition residual structure derived from the same recognition-cost objective;
circuitry and/or one or more processors executing instructions, configured to provide a predetermined fixed damping constant that is not a learning rate and is not tuned during training;
circuitry and/or one or more processors executing instructions, configured to solve a damped linear system formed from the curvature matrix, the gradient, and the fixed damping constant to obtain a parameter-update vector; and
circuitry and/or one or more processors executing instructions, configured to apply the parameter-update vector to the model parameters.

21. A non-transitory computer-readable medium storing instructions that, when executed by one or more processors, cause the one or more processors to perform operations comprising:
computing a recognition-cost objective for a current model state of a machine-learning model;
computing a gradient associated with the recognition-cost objective with respect to model parameters of the machine-learning model;
computing a curvature matrix associated with the same recognition-cost objective or with a recognition residual structure derived from the same recognition-cost objective;
forming a damped linear system from the curvature matrix, the gradient, and a predetermined fixed damping constant that is not a learning rate and is not adjusted during training;
solving the damped linear system to obtain a parameter-update vector; and
updating the model parameters using the parameter-update vector.

22. A hardware accelerator for generating parameter updates for a machine-learning model, the hardware accelerator comprising:
a fixed-damping register configured to store a predetermined fixed damping constant; a block matrix buffer configured to store one or more damped block system matrices; a factorization engine configured to factorize the damped block system matrices formed from block curvature matrices and the fixed damping constant; a forward/back substitution engine configured to generate block update vectors from the factorized damped block system matrices; and an update output buffer configured to output the block update vectors for application to model parameters.

23. The hardware accelerator of claim 22, wherein the factorization engine performs Cholesky factorization on damped block system matrices formed from block curvature matrices and the fixed damping constant.

24. The machine-learning training system of claim 20, wherein the fixed damping constant is established before training begins and remains unchanged across minibatches and epochs.

25. The machine-learning training system of claim 20, wherein parameter blocks are assigned across a plurality of compute devices, each compute device performs local curvature-and-solve operations on an assigned subset of the parameter blocks, and updated parameters or block updates are synchronized after the local curvature-and-solve operations.
